(19) United States
(12) Patent Application Publication
(10) Pub. No.: US 2026/0009977 A1
(43) Pub. Date: Jan. 8, 2026

(54) OPTICAL IMAGING LENS

(71) Applicant: E-PIN OPTICAL INDUSTRY CO., LTD, Taipei City (TW)

(72) Inventors: Chih-Hsiang Yin, Taipei City (TW); Cheng-Hung Hsieh, Taipei City (TW)

(73) Assignee: E-PIN OPTICAL INDUSTRY CO., LTD, Taipei City (TW)

(21) Appl. No.: 18/762,644

(22) Filed: Jul. 3, 2024

(51) Int. Cl. G02B 13/00; G02B 1/08; G02B 1/11; G02B 3/04; G02B 9/60

(52) U.S. Cl. CPC G02B 13/0045; G02B 1/08; G02B 1/11; G02B 3/04; G02B 9/60; G02B 13/0055

(57) ABSTRACT

An optical imaging lens adapted for limited working distance includes a first lens element, a second lens element, a third lens element, a fourth lens element, a fifth lens element, and an image sensing element sequentially arranged along an optical axis from an object side to an image side. Each of the first lens element to the fifth lens element includes an object-side surface facing toward the object side and an image-side surface facing toward the image side. The first lens element is a wide-angle lens element. The second lens element to the fifth lens element are a combination of aspherical lens elements, molded glass lens elements, and free-form surface lens elements. The field of view of the optical imaging lens is greater than or equal to 100 degrees, and the optical imaging lens is a wide-angle lens.

### BACKGROUND

### Technical Field

The disclosure relates to an optical device, and particularly relates to an optical imaging lens.

### Description of Related Art

In recent years, optical imaging lenses have continued to evolve and are used in a wider

range of applications. In addition to requiring lenses to be light, thin, short, and small, a large field of view has gradually become a trend. In the current optical lenses, the working distance of the general lens element group is mostly infinite, or from 200 mm (20 cm) to 1000 mm (1 meter). In the mobile phone market, the commonly used rear camera lenses of the mobile phones are mostly 60 cm to infinity or 30 cm to infinity. Therefore, if there are other special requirements, multiple lenses are often used. Therefore, it is common for the mobile phone to have multiple lens element groups. On the other hand, in non-mobile phone applications, there is a demand for short working distance and long depth of field. At this time, the lens requirements are different from the common lenses. For short-distance requirements, specification planning is generally based on the theory of hyperfocal distance. However, the aforementioned estimation is based on paraxial optics and will have a large error at a large field of view. In addition, there will be more problems when the short distance is within 200 mm (20 cm). How to increase the field of view while also being used for ultra-short distances (such as less than 20 cm or as close as within 3 cm) is one of the development goals in this field. In addition, in the general optical lenses, the field of view of the lens element group is

usually between 60 degrees and 70 degrees, and its optical distortion usually falls between 10% and 20%. Therefore, how to increase the field of view while maintaining low optical distortion is one of the development goals in this field. On the other hand, in order to achieve an effective visual range (or working distance), the general lens element group often uses a voice coil motor (VCM) or other zooming techniques to adjust the lens elements, that is, general autofocus technology, to change the effective visual range (or working distance). Therefore, how to achieve a limited visual range (or working distance) without using additional components and making this range large enough (that is, a long depth of field) for commercial use is also one of the development goals in this field.

In addition, due to cost considerations, the same optical lens needs to be able to be used in different wavelength bands of visible light and infrared light (such as 850 nm or 940 nm). It is one of the development goals in this field to find out how to share the same lens without using additional components but using different coatings to achieve commercial price competitiveness.

### SUMMARY

The disclosure provides an optical imaging lens, which has a large field of view and favorable optical imaging effect, and can be used in short-distance applications with a long limited range of working distance (long depth of field) and different wavelength bands.

The disclosure provides an optical imaging lens adapted for limited working distance, which includes a first lens element, a second lens element, a third lens element, a fourth lens element, a fifth lens element, and an image sensing element sequentially arranged along an optical axis from an object side to an image side, and each of the first lens element to the fifth lens element includes an object-side surface facing toward the object side and an image-side surface facing toward the image side. The first lens element is a wide-angle lens element. The second lens element to the fifth lens element are a combination of aspherical lens elements, molded glass lens elements, and free-form surface lens elements. The field of view of the optical imaging lens is greater than or equal to 100 degrees, and the optical imaging lens is a wide-angle lens.

In an embodiment of the disclosure, the optical imaging lens has only five lens elements.

In an embodiment of the disclosure, the second lens element and fourth lens element are aspherical lens elements, the third lens element is a molded glass lens element, and the fifth lens element is a free-form surface lens element.

In an embodiment of the disclosure, the field of view of the optical imaging lens is less than 150 degrees.

In an embodiment of the disclosure, an effective working distance of the optical imaging lens is greater than or equal to 20 mm and less than or equal to 200 mm.

In an embodiment of the disclosure, the effective working distance of the optical imaging lens is greater than or equal to 100 mm and less than or equal to 500 mm.

In an embodiment of the disclosure, the optical imaging lens satisfies the following conditional formula: CA1/TTL>0.7, where CA1 is an optical effective diameter of the first lens element, and TTL is a distance on the optical axis from the object-side surface of the first lens element to an image plane of the image sensing element.

In an embodiment of the disclosure, the optical imaging lens satisfies the following conditional formula: SD/TTL>0.42, where SD is a diagonal length of the image plane of the image sensing element, and TTL is the distance on the optical axis from the object-side surface of the first lens element to the image sensing element.

In an embodiment of the disclosure, the optical imaging lens satisfies the following conditional formula: 60>RWD/TTL>30, where RWD is a difference between a maximum working distance and a minimum working distance of the optical imaging lens, and TTL is the distance on the optical axis from the object-side surface of the first lens element to the image sensing element.

In an embodiment of the disclosure, the optical imaging lens further includes a filter element configured between the fifth lens element and the image sensing element.

In an embodiment of the disclosure, the optical imaging lens has an anti-total reflection coating for the visible light band or an anti-total reflection coating for the invisible light band.

Based on the above, the optical imaging lens of the disclosure includes a first lens element, a second lens element, a third lens element, a fourth lens element, and a fifth lens element sequentially arranged along the optical axis from the object side to the image side, where the first lens element is a wide-angle lens element, and the second lens element to the fifth lens element are a combination of aspherical lens elements, molded glass lens elements, and free-form surface lens elements. The optical imaging lens is a wide-angle lens having a large field of view.

Additionally, the optical imaging lens is used for limited working distances. In this way, by satisfying the above-mentioned lens type arrangement design and surface conditions, the optical imaging lens can have a larger field of view, improve aberrations, and have excellent imaging quality, and can be used at a limited working distance.

In order to make the above-mentioned features and advantages of the disclosure clearer and easier to understand, the following embodiments are given and described in details with accompanying drawings as follows.

### BRIEF DESCRIPTION OF THE DRAWINGS

FIG. 1 is a schematic diagram of an optical imaging lens according to an embodiment of the disclosure.

FIG. 2 is a schematic diagram of a working distance of the optical imaging lens in FIG. 1.

FIG. 3 is a field curvature aberration graph of the optical imaging lens in FIG. 1.

FIG. 4 is a distortion aberration graph of the optical imaging lens in FIG. 1.

FIG. 5 is a field curvature aberration graph of an optical imaging lens according to another embodiment.

FIG. 6 is a distortion aberration graph of the optical imaging lens according to the embodiment of FIG. 5.

### DESCRIPTION OF THE EMBODIMENTS

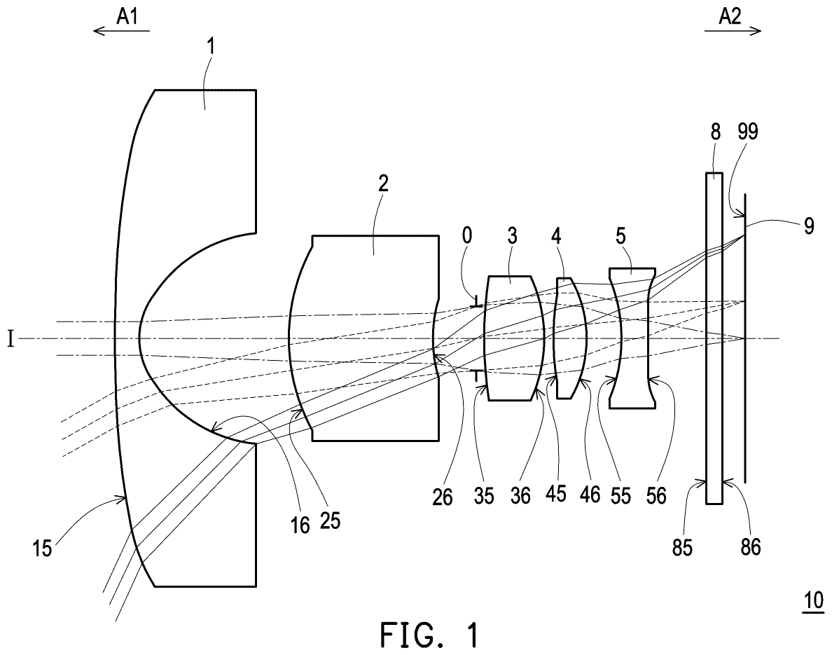

FIG. 1 is a schematic diagram of an optical imaging lens according to an embodiment of the disclosure. Referring to FIG. 1, the embodiment provides an optical imaging lens 10 adapted for limited working distance, and specifically used for a shorter working distance and over a limited long distance. A field of view of the optical imaging lens 10 is greater than or equal to 100 degrees, and the optical imaging lens 10 is a wide-angle lens. In a preferred embodiment, the field of view of the optical imaging lens 10 is greater than or equal to 100 degrees and less than 150 degrees. In terms of application, the optical imaging lens 10 provided in the embodiment can be applied to non-contact optical sensing devices, such as palmprint recognition sensors, or can be used in limited working distance optical devices such as non-contact access control systems, or can be an inspection system that inspects high-view objects and requires precision punching or welding of three-dimensional (3D) electronic circuits, where the objects to be inspected are placed on the inspection platform and the working range thereof is about 10 cm, but the disclosure is not limited thereto.

The optical imaging lens 10 includes a first lens element 1, a second lens element 2, a third lens element 3, a fourth lens element 4, a fifth lens element 5, and an image sensing element 9 sequentially arranged along an optical axis I from an object side A1 to an image side A2. When the ray emitted by an object to be photographed enters the optical imaging lens 10 and passes through the first lens element 1, the second lens element 2, an aperture 0, the third lens element 3, the fourth lens element 4, the fifth lens element 5, and a filter element 8, an image will be formed on an image plane 99 of the image sensing element 9. The filter element 8 is disposed between the image-side surface 56 of the fifth lens element 5 and the image plane 99. It should be added that the object side Al is a side facing toward the object to be photographed, and the image side A2 is a side facing toward an image plane 99. In the embodiment, the filter element 8 is, for example, an infrared cut filter (IR Cut Filter), but the disclosure is not limited thereto. In the embodiment, the optical imaging lens 10 has an anti-total reflection coating for the visible light band or an anti-total reflection coating for the invisible light band. In some embodiments, the optical imaging lens 10 can also be configured with a polarizing element (not shown) in the lens to change the beam polarization state or filter out part of the beam, but the disclosure is not limited thereto.

Specifically, in the embodiment, the first lens element 1 is a wide-angle lens element. The second lens element 2 to the fifth lens element 5 are a combination of aspherical lens elements, molded glass lens elements, and free-form surface lens elements. Each of the first lens element 1 to the fifth lens element 5 and the filter element 8 includes an object-side surface 15, 25, 35, 45, 55, 85 facing toward the object side Al and allowing the imaging ray to pass through, and an image-side surface 16, 26, 36, 46, 56, 86 facing toward the image side A2 and allowing the imaging ray to pass through. In the embodiment, the aperture 0 is placed between the second lens element 2 and the third lens element 3.

Specifically, in the embodiment, the first lens element 1 is a wide-angle lens element. The first lens element 1 has negative refracting power. The object-side surface 15 of the first lens element 1 is a convex surface, and the image-side surface 16 of the first lens element 1 is a concave surface. In the embodiment, the object-side surface 15 and the image-side surface 16 of the first lens element 1 are both aspheric surfaces, but the disclosure is not limited thereto.

The second lens element 2 is an aspherical lens element. The second lens element 2 has positive refracting power. The object-side surface 25 of the second lens element 2 is a convex surface, and the image-side surface 26 of the second lens element 2 is a concave surface. In the embodiment, both the object-side surface 25 and the image-side surface 26 of the second lens element 2 are aspheric surfaces, but the disclosure is not limited thereto.

The third lens element 3 is a molded glass lens element. The third lens element 3 has positive refracting power. The object-side surface 35 of the third lens element 3 is a convex surface, and the image-side surface 36 of the third lens element 3 is a convex surface. In the embodiment, both the object-side surface 35 and the image-side surface 36 of the third lens element 3 are aspheric surfaces, but the disclosure is not limited thereto.

The fourth lens element 4 is an aspherical lens element. The fourth lens element 4 has positive refracting power. The object-side surface 45 of the fourth lens element 4 is a convex surface, and the image-side surface 46 of the fourth lens element 4 is a convex surface. In the embodiment, both the object-side surface 45 and the image-side surface 46 of the fourth lens element 4 are aspheric surfaces, but the disclosure is not limited thereto.

The fifth lens element 5 is a free-form surface lens element. The fifth lens element 5 has negative positive refracting power. The object-side surface 55 of the fifth lens element 5 is a concave surface, and the image-side surface 56 of the fifth lens element 5 is a concave surface. In the embodiment, both the object-side surface 55 and the image-side surface 56 of the fifth lens element 5 are free-form surfaces, but the disclosure is not limited thereto. In the embodiment, the optical imaging lens 10 has only the above five lens elements.

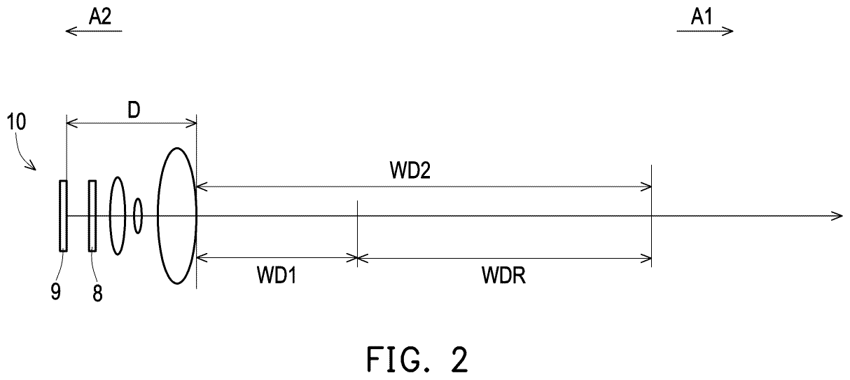

FIG. 2 is a schematic diagram of a working distance of the optical imaging lens in FIG. 1. Referring to FIG. 1 and FIG. 2, it is worth mentioning that in the embodiment, the optical imaging lens 10 has a minimum working distance WD1 and a non-infinite maximum working distance WD2, and the maximum working distance WD2 to the minimum working distance WD1 can be defined as a working distance range WDR. In the embodiment, an effective working distance of the optical imaging lens 10 is greater than or equal to 20 mm and less than or equal to 200 mm. That is, the minimum working distance WD1 is 20 mm, the maximum working distance WD2 is 200 mm, and the working distance range WDR is 180 mm. In another embodiment, the effective working distance of the optical imaging lens can also be designed to be greater than or equal to 100 mm and less than or equal to 500 mm, but the disclosure is not limited thereto. That is, the minimum working distance WD1 is 100 mm, the maximum working distance WD2 is 500 mm, and the working distance range WDR is 400 mm.

In addition, when the optical imaging lens 10 satisfies the following conditional formula, favorable imaging effect can be further improved, wherein:
the optical imaging lens 10 can comply with CA1/TTL>0.7;
the optical imaging lens 10 can comply with SD/TTL>0.42; and
the optical imaging lens 10 can comply with 60>RWD/TTL>30,
wherein,
CA1 is the optical effective diameter of the first lens element 1;
TTL is the distance D on the optical axis I from the object-side surface 15 of the first lens element 1 to the image plane 99 of the image sensing element 9;
SD is the diagonal length of the image plane 99 of the image sensing element 9;
RWD is the difference between the minimum working distance WD1 and the maximum working distance WD2 of the optical imaging lens 10 (i.e., the working distance range WDR).

TABLE 1
system length = 7.560 mm, effective focal length =
0.6802 mm, image height = 1.910 mm, horizontal field
of view = 130.000°, vertical field of view = 120.000°, F-number = 1.520

| | | Radius of | Thickness | Refractive | Abbe |
|---|---|---|---|---|---|
| Element | Surface | curvature (mm) | (mm) | index | number |
| Object | | Infinite | 20−200 | | |
| First lens element 1 | Object-side | 14.9964 | 0.3260 | 1.54 | 56.0 |
| | surface 15 | | | | |
| | Image-side | 0.8608 | 1.9789 | | |
| | surface 16 | | | | |
| Second lens element 2 | Object-side | 2.6240 | 1.9000 | 1.66 | 20.4 |
| | surface 25 | | | | |
| | Image-side | 2.0443 | 0.5816 | | |
| | surface 26 | | | | |
| Aperture 0 | | Infinite | 0.1003 | | |
| Third lens element 3 | Object-side | 3.9950 | 0.8013 | 1.67 | 55.4 |
| | surface 35 | | | | |
| | Image-side | −2.0414 | 0.1195 | | |
| | surface 36 | | | | |
| Fourth lens element 4 | Object-side | 3.7371 | 0.4375 | 1.54 | 56.0 |
| | surface 45 | | | | |
| | Image-side | −1.8534 | 0.4641 | | |
| | surface 46 | | | | |
| Fifth lens element 5 | Object-side | −1.4021 | 0.3500 | 1.66 | 20.4 |
| | surface 55 | | | | |
| | Image-side | −1.6124 | 0.7781 | | |
| | surface 56 | | | | |
| Filter element 8 | Object-side | Infinite | 0.2100 | 1.52 | 54.5 |
| | surface 85 | | | | |
| | Image-side | Infinite | >0.3 | | |
| | surface 86 | | | | |
| | Image plane 99 | Infinite | 0.0000 | | |

Table 1 shows the detailed optical data of the optical imaging lens in FIG. 1. Referring to FIG. 1 and Table 1, the effective focal length (EFL) of the optical imaging lens 10 of the embodiment is 0.6802 millimeters (mm), the horizontal field of view (HFOV) is 130.000 degrees, the vertical field of view (VFOV) is 120.000 degrees, the system length is approximately 7.56 mm, the F-number (Fno) is 1.52, the image height is approximately 1.91 mm, wherein the system length refers to the distance on the optical axis I from the object-side surface 15 of the first lens element 1 to the image plane 99.

TABLE 2

| Surface | 15 | 16 | 25 | 26 | 35 | 36 | 45 | 46 |
|---|---|---|---|---|---|---|---|---|
| Conic | 1.8461E+01 | −6.4360E−01 | −3.1360E−01 | 0.0000E+00 | −1.5201E+01 | −6.8376E−01 | −5.0000E+01 | 0.0000E+00 |
| Constant | | | | | | | | |
| 1st Order | 0.0000E+00 | 0.0000E+00 | 0.0000E+00 | 0.0000E+00 | 0.0000E+00 | 0.0000E+00 | 0.0000E+00 | 0.0000E+00 |
| Coefficient | | | | | | | | |
| 2nd Order | 0.0000E+00 | 0.0000E+00 | 0.0000E+00 | 0.0000E+00 | 0.0000E+00 | 0.0000E+00 | 0.0000E+00 | 0.0000E+00 |
| Coefficient | | | | | | | | |
| 3rd Order | 0.0000E+00 | 0.0000E+00 | 0.0000E+00 | 0.0000E+00 | 0.0000E+00 | 0.0000E+00 | 2.7883E−03 | 0.0000E+00 |
| Coefficient | | | | | | | | |
| 4th Order | −2.0800E−03 | −1.1034E−01 | −2.8575E−02 | 9.2751E−02 | −2.4028E−02 | −1.9078E−02 | 6.9818E−02 | −4.1270E−02 |
| Coefficient | | | | | | | | |
| 5th Order | 1.2710E−07 | −1.6087E−04 | 1.1526E−03 | 3.1558E−03 | 0.0000E+00 | 0.0000E+00 | 1.5256E−03 | 6.0560E−04 |
| Coefficient | | | | | | | | |
| 6th Order | 3.3165E−05 | 7.2840E−03 | 1.9485E−02 | −2.2674E−02 | −1.6571E−02 | −4.4188E−03 | −1.0818E−01 | 1.2665E−02 |
| Coefficient | | | | | | | | |
| 7th Order | 8.1951E−09 | −4.1017E−05 | −2.9108E−05 | 4.3066E−02 | 0.0000E+00 | 0.0000E+00 | 1.4293E−03 | 3.0308E−03 |
| Coefficient | | | | | | | | |
| 8th Order | 1.1949E−05 | −2.0841E−03 | 3.2187E−03 | 8.4591E−01 | 1.1506E−02 | −8.9953E−04 | −5.5833E−02 | 7.9249E−04 |
| Coefficient | | | | | | | | |
| 9th Order | 3.4245E−10 | −7.3253E−06 | −1.9314E−04 | 9.8527E−02 | 0.0000E+00 | 0.0000E+00 | −3.8774E−03 | −4.1446E−03 |
| Coefficient | | | | | | | | |
| 10th Order | 7.5112E−06 | −2.4846E−03 | −1.7802E−03 | −1.3413E+00 | 1.0210E−01 | −5.2690E−04 | −2.8923E−02 | −6.8711E−02 |
| Coefficient | | | | | | | | |
| 11th Order | 2.1596E−11 | 8.7553E−07 | −1.5694E−04 | 6.3881E−02 | | | −2.5176E−02 | −2.1141E−02 |
| Coefficient | | | | | | | | |
| 12th Order | −3.8426E−07 | 5.7555E−03 | 6.7414E−04 | 7.2731E−01 | | | 5.9310E−01 | −2.4056E−01 |
| Coefficient | | | | | | | | |
| 13th Order | 1.3117E−11 | 2.0207E−06 | −7.9464E−05 | −4.8363E−01 | | | −7.5167E−02 | −4.3268E−02 |
| Coefficient | | | | | | | | |
| 14th Order | −1.1104E−07 | −2.7175E−03 | 2.5758E−03 | −1.2512E+00 | | | −1.0918E+00 | 2.7754E−01 |
| Coefficient | | | | | | | | |
| 15th Order | 1.6443E−12 | 0.0000E+00 | −2.3873E−05 | −2.5846E+00 | | | −1.5095E−01 | −5.5690E−02 |
| Coefficient | | | | | | | | |
| 16th Order | 7.4946E−09 | −4.5589E−03 | −8.6087E−03 | −4.6148E+00 | | | 1.3547E−01 | −7.1895E−02 |
| Coefficient | | | | | | | | |
| 17th Order | 0.0000E+00 | 1.0253E−06 | 1.0043E−05 | −6.9945E+00 | | | −1.5825E−01 | −2.0907E−02 |
| Coefficient | | | | | | | | |
| 18th Order | 3.1005E−12 | 3.5468E−03 | 8.2439E−03 | −8.0426E+00 | | | −4.9368E−02 | 3.6790E−02 |
| Coefficient | | | | | | | | |
| 19th Order | −8.3724E−16 | 7.2571E−07 | 2.9903E−05 | −1.9952E+00 | | | 2.8826E−01 | 0.0000E+00 |
| Coefficient | | | | | | | | |
| 20th Order | 2.2691E−13 | −5.9937E−04 | −2.5415E−03 | 2.5009E+01 | | | 1.0328E+00 | 0.0000E+00 |
| Coefficient | | | | | | | | |

Table 2 shows the aspheric surface parameters of the optical imaging lens in FIG. 1. Referring to FIG. 1 and Table 2, in addition, in the embodiment, eight surfaces in total of the object-side surfaces 15, 25, 35, 45 and image-side surfaces 16, 26, 36, 46 of the first lens element 1, the second lens element 2, the third lens element 3, and the fourth lens element 4 are all aspheric surfaces, wherein the object-side surfaces 15, 25, 35, 45 and the image-side surfaces 16, 26, 36, 46 are general even asphere surfaces. These aspheric surfaces are defined according to the following formula (1):

$$z = \frac{{cr}^{2}}{1 + \sqrt{1 - ( 1 + k ) {c}^{2} {r}^{2}}} + AR 1 r + AR 2 {r}^{2} + AR 3 {r}^{3} + … + {ARnr}^{n} + … + AR 30 {r}^{30} \qquad ( 1 )$$

wherein:
z: depth of aspheric surface (vertical distance between the point on the aspheric surface for which the distance from the optical axis I is Y and the cross section tangent to the vertex on the aspheric surface optical axis I);
c: curvature of surface vertex;
k: conic constant;
r: radial distance;
ARn: aspheric surface coefficient of rⁿ (1≤n≤30).

The aspheric surface coefficients in formula (1) from the object-side surface 15 of the first lens element 1 to the image-side surface 46 of the fourth lens element 4 are shown in Table 2, wherein field number 15 in Table 2 indicates the aspheric surface coefficient of the object-side surface 15 of the first lens element 1, and the other fields are defined in a similar manner.

TABLE 3

| Surface | 55 | 56 | | 55 | 56 | | 55 | 56 |
|---|---|---|---|---|---|---|---|---|
| Conic Constant | 0.0000E+00 | −1.0144E+01 | X**6 | −1.4884E−01 | −1.1565E−01 | X**9 | 3.1295E−02 | 8.8417E−03 |
| X | −1.6021E−03 | −8.9277E−03 | X**5 * Y | 2.6505E−02 | 2.8028E−02 | X**8 * Y | −4.4101E−02 | −2.6742E−02 |
| Y | 7.4826E−04 | 8.9600E−04 | X**4 * Y**2 | 2.5404E−01 | −1.3274E−01 | X**7 * Y**2 | −1.3664E−01 | −7.5846E−02 |
| X**2 | −5.0981E−02 | 9.4268E−02 | X**3 * Y**3 | 4.6405E−02 | 3.6714E−02 | X**6 * Y**3 | −1.2344E−01 | −6.2116E−02 |
| X * Y | 1.0244E−04 | 1.5365E−04 | X**2 * Y**4 | −4.0352E−01 | −3.7085E−01 | X**5 * Y**4 | −1.2940E−01 | −1.7143E−01 |
| Y**2 | 4.2579E−02 | 2.1335E−01 | X * Y**5 | −8.3799E−03 | −1.1345E−02 | X**4 * Y**5 | −1.0197E−01 | −7.8871E−02 |
| X**3 | −1.5195E−02 | −1.7459E−02 | Y**6 | −2.1347E−01 | −1.5566E−01 | X**3 * Y**6 | 1.3803E−02 | −1.5256E−02 |
| X**2 * Y | 7.6758E−05 | 3.6613E−04 | X**7 | −8.8566E−03 | 4.1646E−03 | X**2 * Y**7 | −3.4399E−02 | −3.7700E−02 |
| X Y**2 | −6.0560E−03 | −8.6503E−03 | X**6 * Y | 3.9973E−02 | 2.9071E−02 | X * Y**8 | 3.9747E−03 | −4.6960E−03 |
| Y**3 | −1.6378E−03 | −1.7533E−03 | X**5 * Y**2 | 1.0652E−01 | 8.9730E−02 | Y**9 | 3.7555E−03 | 4.1699E−03 |
| X**4 | 3.1593E−01 | 2.0595E−01 | X**4 * Y**3 | 6.9137E−02 | 5.2525E−02 | X**10 | 1.0586E−01 | −3.1052E−02 |
| X**3 * Y | −5.9098E−03 | −6.8721E−03 | X**3 * Y**4 | 7.0721E−02 | 8.3313E−02 | X**9 * Y | −8.4692E−02 | −2.1916E−02 |
| X**2 * Y**2 | 4.8835E−01 | 3.1621E−01 | X**2 * Y**5 | 1.8767E−02 | 2.7589E−02 | X**8 * Y**2 | 7.6270E+00 | 2.3884E+00 |
| X * Y**3 | 1.9870E−03 | 2.5071E−03 | X * Y**6 | 1.8786E−02 | 2.1630E−02 | X**7 * Y**3 | 3.0480E−01 | 1.9289E−01 |
| Y**4 | 2.8014E−01 | 2.1186E−01 | Y**7 | −4.4751E−03 | −5.7042E−03 | X**6 * Y**4 | 3.8245E+00 | −1.2847E+00 |
| X**5 | 5.1264E−03 | −5.0062E−03 | X**8 | −2.8995E−02 | 9.0001E−02 | X**5 * Y**5 | 4.6242E−01 | 1.9916E−01 |
| X**4 * Y | −1.1783E−02 | −1.0716E−02 | X**7 * Y | −2.4734E−03 | −2.2312E−02 | X**4 * Y**6 | −4.8732E+00 | −5.0711E+00 |
| X**3 * Y**2 | −1.6015E−03 | −1.3408E−02 | X**6 * Y**2 | −5.0956E+00 | −1.7973E+00 | X**3 * Y**7 | 2.7371E−01 | 1.1252E−01 |
| X**2 * Y**3 | −4.7061E−03 | −6.6479E−03 | X**5 * Y**3 | −2.5700E−01 | −1.7623E−01 | X**2 * Y**8 | 1.3378E+00 | 1.3284E−01 |
| X * Y**4 | −6.1259E−03 | −1.2324E−02 | X**4 * Y**4 | 5.9684E−01 | 2.2642E+00 | X * Y**9 | 3.6975E−03 | −7.1545E−03 |
| Y**5 | 3.0704E−03 | 3.6046E−03 | X**3 * Y**5 | −1.8090E−01 | −9.9707E−02 | Y**10 | 1.3783E−01 | 2.7472E−02 |
| | | | X**2 * Y**6 | −1.9464E−01 | 3.9151E−01 | | | |
| | | | X * Y**7 | 6.2897E−03 | 1.6097E−02 | | | |
| | | | Y**8 | 1.2354E−02 | 6.4397E−02 | | | |

Table 3 shows the free-form surface parameters of the optical imaging lens in FIG. 1. Referring to FIG. 1 and Table 3, in addition, in the embodiment, the object-side surface 55 and the image-side surface 56 of the fifth lens element 5 are two free-form surfaces, and these free- form surfaces are defined according to the following formula (2):

$$z = \frac{{cr}^{2}}{1 + \sqrt{1 - ( 1 + k ) {c}^{2} {r}^{2}}} + {\sum }_{j = 2}^{66} {C}_{j} {x}^{m} {y}^{n} \\ j = \frac{{( m + n )}^{2} + m + 3 n}{2} \qquad ( 2 )$$

wherein:
z: depth of aspheric surface (vertical distance between the point on the aspheric surface for which the distance from the optical axis I is Y and the cross section tangent to the vertex on the aspheric surface optical axis I);
c: curvature of surface vertex;
k: conic constant;
Cⱼ: coefficient of x^{m}yⁿ monomial.

The free-form surface coefficients of the object-side surface 55 and the image-side surface 56 of the fifth lens element 5 in formula (2) are as shown in Table 3.

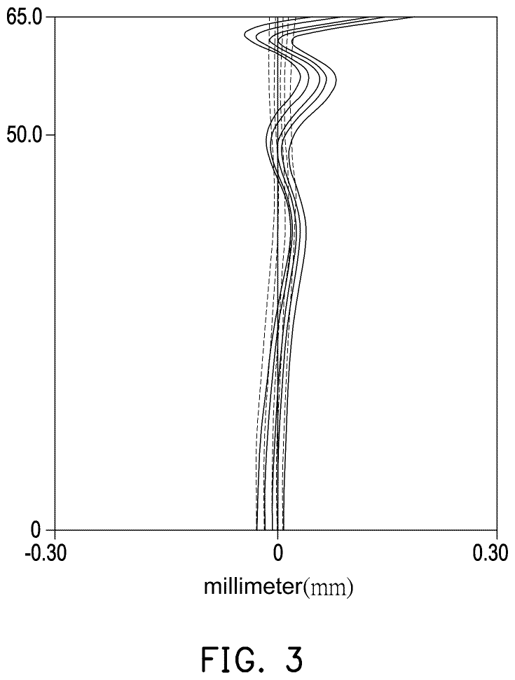

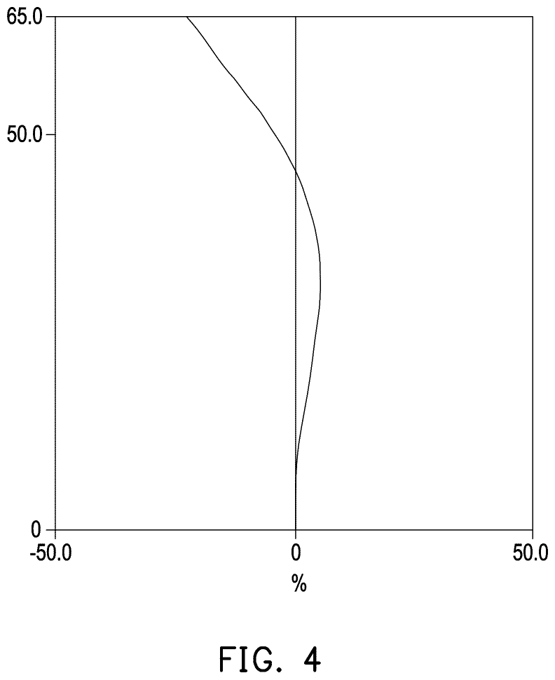

FIG. 3 is a field curvature aberration graph of the optical imaging lens in FIG. 1. FIG. 4 is a distortion aberration graph of the optical imaging lens in FIG. 1. Referring to FIG. 3 and FIG. 4 together, FIG. 3 illustrates the field curvature aberration in the sagittal direction and the field curvature aberration in the tangential direction on the image plane 99 when the wavelengths of the embodiment are 435 nm, 486 nm, 546 nm, 587 nm, and 656 nm, and FIG. 4 illustrates the distortion aberration on the image plane 99 when the wavelengths of the embodiment are 435 nm, 486 nm, 546 nm, 587 nm, and 656 nm. In the field curvature aberration diagram of FIG. 3, the focal length variation of the five representative wavelengths in the entire field of view is within the range of ±0.30 mm, and the field curvature aberration in the half field of view less than 50 degrees can be further maintained within the range of ±0.06 mm, indicating that the optical system of the embodiment can effectively eliminate aberrations. The distortion aberration diagram in FIG. 4 shows that the distortion aberration of the embodiment is maintained within the range of ±25%, and the distortion aberration in the half field of view less than 50 degrees can be further maintained within the range of ±5%, indicating that the distortion aberration of the embodiment also meets the imaging quality requirements of the optical system under a large field of view.

Accordingly, compared with the existing optical lens, the embodiment can still provide favorable imaging quality under the condition of having a large field of view. Therefore, the embodiment can have a wider field of view, a smaller optical distortion, and favorable imaging effect under the condition of having a limited working distance.

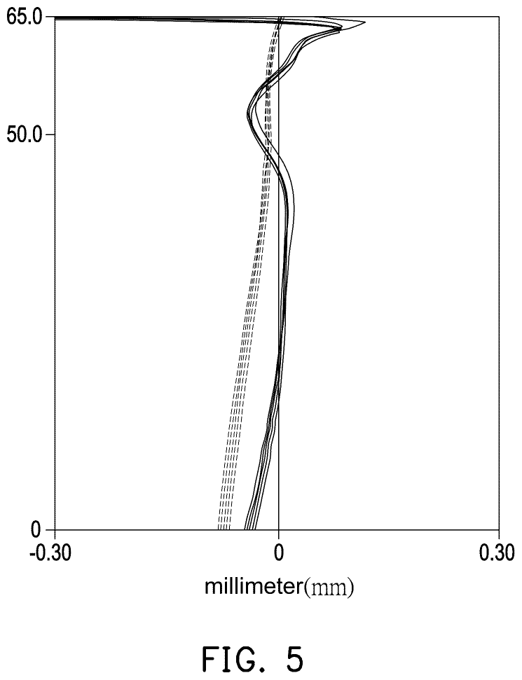

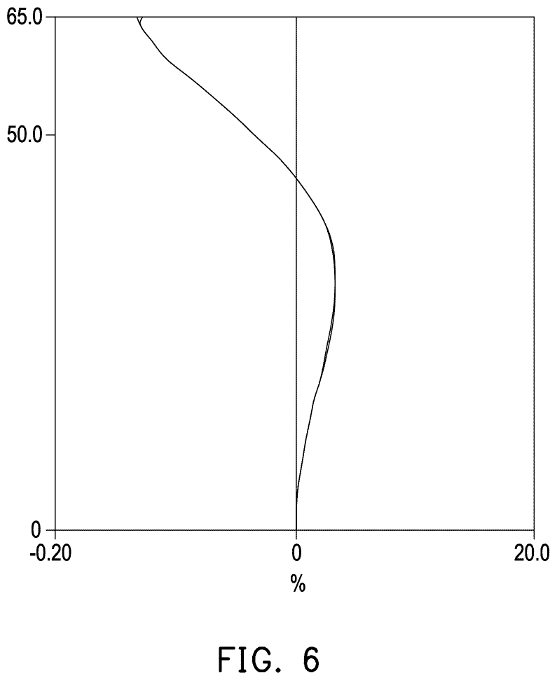

FIG. 5 is a field curvature aberration graph of an optical imaging lens according to another embodiment. FIG. 6 is a distortion aberration graph of the optical imaging lens according to the embodiment of FIG. 5. Referring to FIG. 5 and FIG. 6, in the field curvature aberration diagram of another embodiment, the focal length variation of the five representative wavelengths in the entire field of view also falls within ±0.30 mm, indicating that the optical system of the embodiment can effectively eliminate aberrations. The distortion aberration diagram shows that the distortion aberration of the embodiment can be further maintained within the range of ±13%, and the distortion aberration in the range of the half field of view less than 55 degrees can be further maintained within the range of ±5%, indicating that the distortion aberration of the embodiment meets the imaging quality requirements of the optical system. Accordingly, compared with the existing optical lens, the embodiment can still provide favorable imaging quality under the condition of having a large field of view. Therefore, the embodiment can have a wider field of view, a smaller optical distortion, and favorable imaging effect under the condition of having a limited working distance.

The embodiments of the disclosure are all implementable. In addition, a combination of partial features in a same embodiment can be selected, and the combination of partial features can achieve the unexpected result of the invention with respect to the prior art. The combination of partial features includes but is not limited to the surface shape of a lens element, a refracting power, a conditional expression or the like, or a combination thereof. The description of the embodiments is for explaining the specific embodiments of the principles of the invention, but the invention is not limited thereto. Specifically, the embodiments and the drawings are for exemplifying, but the invention is not limited thereto.

To sum up, the optical imaging lens of the disclosure includes a first lens element, a second lens element, a third lens element, a fourth lens element, and a fifth lens element sequentially arranged along the optical axis from the object side to the image side, where the first lens element is a wide-angle lens element, the second lens element to the fifth lens element are a combination of aspherical lens elements, molded glass lens elements, and free-form surface lens elements. The optical imaging lens is a wide-angle lens with a large field of view. Additionally, the optical imaging lens is used for limited working distances. In this way, by satisfying the above-mentioned lens type arrangement design and surface conditions, the optical imaging lens can have a larger field of view, improve aberrations, and have excellent imaging quality, and can be used at a limited working distance.

Although the disclosure has been described with reference to the embodiments above, the embodiments are not intended to limit the disclosure. Any person skilled in the art can make some changes and modifications without departing from the spirit and scope of the disclosure. Therefore, the scope of the disclosure will be defined in the appended claims.

What is claimed is:

1. An optical imaging lens adapted for limited working distance, comprising a first lens element, a second lens element, a third lens element, a fourth lens element, a fifth lens element, and an image sensing element sequentially arranged along an optical axis from an object side to an image side, wherein each of the first lens element to the fifth lens element comprises the object-side surface facing toward the object side and an image-side surface facing toward the image side, wherein:
the first lens element is a wide-angle lens element;
the second lens element to the fifth lens element are a combination of aspherical lens elements, molded glass lens elements, and free-form surface lens elements; and
a field of view of the optical imaging lens is greater than or equal to 100 degrees, and the optical imaging lens is a wide-angle lens.

2. The optical imaging lens according to claim 1, wherein the optical imaging lens has only five lens elements.

3. The optical imaging lens according to claim 1, wherein the second lens element and the fourth lens element are aspherical lens elements, the third lens element is a molded glass lens element, and the fifth lens element is a free-form surface lens element.

4. The optical imaging lens according to claim 1, wherein the field of view of the optical imaging lens is less than 150 degrees.

5. The optical imaging lens according to claim 1, wherein an effective working distance of the optical imaging lens is greater than or equal to 20 mm and less than or equal to 200 mm.

6. The optical imaging lens according to claim 1, wherein an effective working distance of the optical imaging lens is greater than or equal to 100 mm and less than or equal to 500 mm.

7. The optical imaging lens according to claim 1, wherein the optical imaging lens satisfies the following conditional formula: CA1/TTL>0.7, CA1 is an optical effective diameter of the first lens element, and TTL is a distance on the optical axis from the object-side surface of the first lens element to an image plane of the image sensing element.

8. The optical imaging lens according to claim 1, wherein the optical imaging lens satisfies the following conditional formula: SD/TTL>0.42, SD is a diagonal length of an image plane of the image sensing element, and TTL is a distance on the optical axis from the object-side surface of the first lens element to the image sensing element.

9. The optical imaging lens according to claim 1, wherein the optical imaging lens satisfies the following conditional formula: 60>RWD/TTL>30, RWD is a difference between a maximum working distance and a minimum working distance of the optical imaging lens, and TTL is a distance on the optical axis from the object-side surface of the first lens element to the image sensing element.

10. The optical imaging lens according to claim 1, further comprising:
a filter element, configured between the fifth lens element and the image sensing element.

11. The optical imaging lens according to claim 1, wherein the optical imaging lens has an anti-total reflection coating for a visible light band or an anti-total reflection coating for an invisible light band.

12. The optical imaging lens according to claim 1, further comprising:
a polarizing element, configured in the lens.
